(19) United States
(12) Patent Application Publication
(10) Pub. No.: US 2025/0354888 A1
(43) Pub. Date: Nov. 20, 2025

(54) SYSTEMS AND METHODS FOR BENCHMARKING HEADPHONES

(71) Applicant: Harman International Industries, Incorporated, Stamford, CT (US)

(72) Inventors: Todd S. WELTI, Thousand Oaks, CA (US); Sean Edward OLIVE, Oak Park, CA (US); Christian Manuel GARCIA, Winnetka, CA (US)

(73) Assignee: Harman International Industries, Incorporated, Stamford, CT (US)

(21) Appl. No.: 18/669,189

(22) Filed: May 20, 2024

(51) Int. Cl. G01M 3/24; G10K 11/16; H04R 1/10; H04R 29/00

(52) U.S. Cl. CPC G01M 3/24; G10K 11/16; H04R 1/1091; H04R 29/00

(57) ABSTRACT

A method including the determination of a correlation between a plurality of anthropometric features and an amount of acoustical leakage associated with a first set of headphones, the selection of a subset of anthropometric features from the plurality of anthropometric features having a highest correlation to the amount of acoustical leakage, the clustering of the selected anthropometric features using a clustering algorithm, and the construction of a set of test objects based on one or more three-dimensional scans associated with the clustered anthropometric features.

### FIELD

The present disclosure relates to the design of a test object, and more particularly, to systems and methods for predicting acoustical-related measurements based on the test object.

### BACKGROUND

The statements in this section merely provide background information related to the present disclosure and may not constitute prior art.

Acoustical leakage is an inherent issue present within headphones due to the wide variety of different individuals having different anthropometric features that may use the headphones. More specifically, acoustical leakage related to headphones may vary based on a variety of physical characteristics associated with headphone user demographics, such as gender, race, and/or ethnicity. Because of the wide variance of these demographics, design of a new set of headphones to mitigate acoustical leakage can be time-consuming.

The present disclosure addresses these and other issues related to the efficient design of a new set of headphones.

### SUMMARY

This section provides a general summary of the disclosure and is not a comprehensive disclosure of its full scope or all of its features.

The present disclosure provides a method comprising: determining, by a processor using a regression model, a correlation between a plurality of anthropometric features and an amount of acoustical leakage associated with a first set of headphones; selecting, for clustering, based on the determined correlation, a subset of anthropometric features from the plurality of anthropometric features having a highest correlation to the amount of acoustical leakage; clustering, by the processor, the selected anthropometric features using a clustering algorithm; and constructing a set of test objects based on one or more three-dimensional scans associated with the clustered anthropometric features; further comprising: obtaining, from each human subject of a plurality of human subjects, a data set, wherein the data set includes the amount of acoustical leakage, the one or more three-dimensional scans, or a combination thereof; further comprising: identifying a plurality of anthropometric landmarks associated with each human subject of the plurality of human subjects based on the one or more three-dimensional scans; and identifying the plurality of anthropometric features based on the plurality of anthropometric landmarks; further comprising: identifying the clustered anthropometric features based on one or more clustering metrics; further comprising: determining, for a plurality of human subjects, a first set of acoustical-related measurements associated with a second set of headphones, wherein the first set of acoustical-related measurements includes an average acoustical leakage and an average variance associated with the average acoustical leakage; and determining, for the set of test objects, a second set of acoustical-related measurements associated with the second set of headphones, wherein the second set of acoustical-related measurements includes an average acoustical leakage and an average variance associated with the average acoustical leakage; further comprising: generating a regression line based on a correlation between the first set of acoustical-related measurements and the second set of acoustical-related measurements; and further comprising: predicting, based on a slope of the regression line, an average acoustical leakage and an average variance associated with a general population of humans.

The present disclosure provides a system comprising: a processor; and a non-transitory computer-readable medium including instructions that are executable by the processor, wherein the instructions include: determining, by the processor using a regression model, a correlation between a plurality of anthropometric features and an amount of acoustical leakage associated with a first set of headphones; selecting, for clustering, based on the determined correlation, a subset of anthropometric features from the plurality of anthropometric features having a highest correlation to the amount of acoustical leakage; clustering, by the processor, the selected anthropometric features using a clustering algorithm; and constructing a set of test objects based on one or more three-dimensional scans associated with the clustered anthropometric features; wherein the instructions further include: obtaining, from each human subject of a plurality of human subjects, a data set, wherein the data set includes the amount of acoustical leakage, the one or more three-dimensional scans, or a combination thereof; wherein the instructions further include: identifying a plurality of anthropometric landmarks associated with each human subject of the plurality of human subjects based on the one or more three-dimensional scans; and identifying the plurality of anthropometric features based on the plurality of anthropometric landmarks; wherein the instructions further include: identifying the clustered anthropometric features based on one or more clustering metrics; wherein the instructions further include: determining, for a plurality of human subjects, a first set of acoustical-related measurements associated with a second set of headphones, wherein the first set of acoustical-related measurements includes an average acoustical leakage and an average variance associated with the average acoustical leakage; determining, for the set of test objects, a second set of acoustical-related measurements associated with the second set of headphones, wherein the second set of acoustical-related measurements includes an average acoustical leakage and an average variance associated with the average acoustical leakage; and generating a regression line based on a correlation between the first set of acoustical-related measurements and the second set of acoustical-related measurements; and wherein the instructions further include: predicting, based on a slope of the regression line, an average acoustical leakage and an average variance associated with a general population of humans.

The present disclosure provides a method comprising: generating a regression line based on a correlation between a first set of acoustical-related measurements and a second set of acoustical-related measurements, wherein the first set of acoustical-related measurements are associated with a plurality of human subjects and includes an average acoustical leakage and an average variance associated with the average acoustical leakage, and wherein the second set of acoustical-related measurements is associated with a set of test objects and includes an average acoustical leakage and an average variance associated with the average acoustical leakage; and predicting, based on a slope of the regression line, an average acoustical leakage and an average variance associated with a general population of humans, wherein each of the prediction of the average acoustical leakage and the average variance are associated with a first set of headphones; further comprising: constructing the set of test objects based on one or more three-dimensional scans associated with clustered anthropometric features, wherein a subset of anthropometric features from a plurality of anthropometric features are clustered by a processor using a clustering algorithm; wherein the subset of anthropometric features are selected based on a highest correlation to an amount of acoustical leakage associated with a second set of headphones; wherein the highest correlation is determined by the processor using a regression model based on a determination of a correlation between the subset of anthropometric features and the amount of acoustical leakage associated with the second set of headphones; further comprising: obtaining, from each human subject of the plurality of human subjects, a data set, wherein the data set includes the amount of acoustical leakage associated with the second set of headphones, the one or more three-dimensional scans, or a combination thereof; further comprising: identifying a plurality of anthropometric landmarks associated with each human subject of the plurality of human subjects based on the one or more three-dimensional scans; and identifying the plurality of anthropometric features based on the plurality of anthropometric landmarks; and further comprising: identifying the clustered anthropometric features based on one or more clustering metrics.

### DRAWINGS

In order that the disclosure may be well understood, there will now be described various forms thereof, given by way of example, reference being made to the accompanying drawings, in which:

FIG. 1 is a block diagram of a system to design a set of test objects in accordance with one or more embodiments of the present disclosure;

FIGS. 2A and 2B are diagrams illustrating a plurality of anthropometric features and three-dimensional scans of a human subject in accordance with one or more embodiments of the present disclosure;

FIGS. 3A and 3B are schematic views of the constructed test object(s) in accordance with one or more embodiments of the present disclosure;

FIG. 4 is a flowchart illustrating an example method for constructing the test object in accordance with one or more embodiments of the present disclosure;

FIG. 5 is a flowchart illustrating an example method for predicting the average acoustical leakage and the average variance of the acoustical leakage for the general population of humans in accordance with one or more embodiments of the present disclosure;

FIG. 6 is a process-flow diagram illustrating an example method for constructing the set of test objects in accordance with one or more embodiments of the present disclosure; and

FIG. 7 is block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more embodiments of the present disclosure provide systems and methods for predicting acoustical-related measurements based on a test object (e.g., a mannequin head, manikin head, model head, etc.) designed using a plurality of anthropometric features. For example, a methodology for designing a set of test objects to be used for benchmarking headphones is provided in one or more embodiments. It is understood that “benchmarking,” in one or more embodiments, refers to predicting an amount and variability of acoustical leakage for a given set of headphones as worn on humans. More specifically, “benchmarking” means to predict how much the acoustical response of the set of headphones may vary when placed on different humans, due to varying amounts of acoustical leakage, for example.

As an example, acoustical leakage refers to a small gap(s) in a seal of headphone cups relative to the head/ears of the human wearing the headphones. Such acoustical leaks can cause large and/or variable amounts of loss of low frequency energy, thus greatly affecting the sound quality of the headphones. In consideration of such a loss of energy, it is beneficial to determine such loss issues when designing headphones, such as in advance of commercialization of the headphones. It is understood that commercialization refers to the production of the headphones and/or the offering for human use of the headphones.

With one or more embodiments, obtaining acoustical-related measurements can be improved using a set of engineered test objects (e.g., more than one mannequin), as described in more detail herein, that allows for a repeatable and easier way to qualify sets of headphones than measuring the sets of headphones on a large set of human subjects, thereby facilitating optimization of the headphone design. That is, determining whether a set of headphones under design has any loss issues allows for efficient mitigation efforts relative to the design of the set of headphones before being commercialized. For example, in a case wherein loss issues are determined (e.g., detected using one or more herein described test objects), changes can be made to the design to improve performance (e.g., reduce acoustical leakage) of the set of headphones.

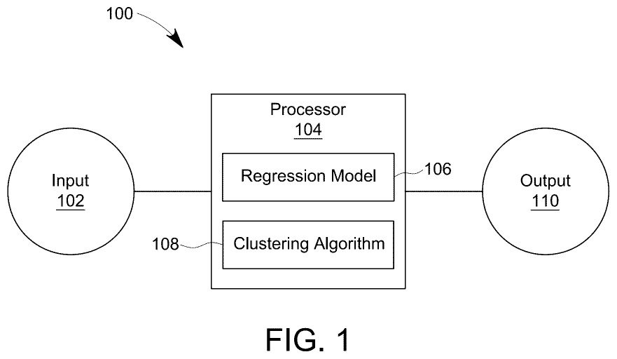

FIG. 1 illustrates an example system 100 associated with the design and subsequent construction of a test object (e.g., a test object 300a-300d illustrated as a test head or “dummy” or mannequin head) that can be used to predict one or more operational characteristics or properties of the set of headphones based on a set of acoustical-related measurements. For example, the set of acoustical-related measurements may include an average acoustical leakage associated with a general population of humans and/or an average variance associated with the average acoustical leakage.

In one or more embodiments, the system 100 is configured to calculate properties and/or characteristics for use in designing the test object(s) 300a-300d. For example, a base data set is obtained as an input 102. For example, the base data set is associated with a plurality of human subjects (e.g., 330 human subjects or any number of human subjects), as described in more detail herein, and used to test a base set of headphones. It is understood that the base set of headphones can be any set of headphones that may be generically used as a basis for improvements (e.g., engineering and/or design improvements) associated with such headphones or any set of headphones. However, it is also understood that the base set of headphones can be an initial version of a headphone model that can represent a headphone under design before any improvements are made based on the base data set. As another example, the human subjects used to generate the base data set are selected in a way that mitigates any demographically-based biases such as gender, race, and/or ethnicity. The unbiased selection of the human subjects, in one or more embodiments, may cause the base data set to provide a more accurate representation of the general population of humans. As an additional example, while the human subjects may be selected by a computer-generated screening tool, any means of selecting the human subjects may be utilized such as by human-decision.

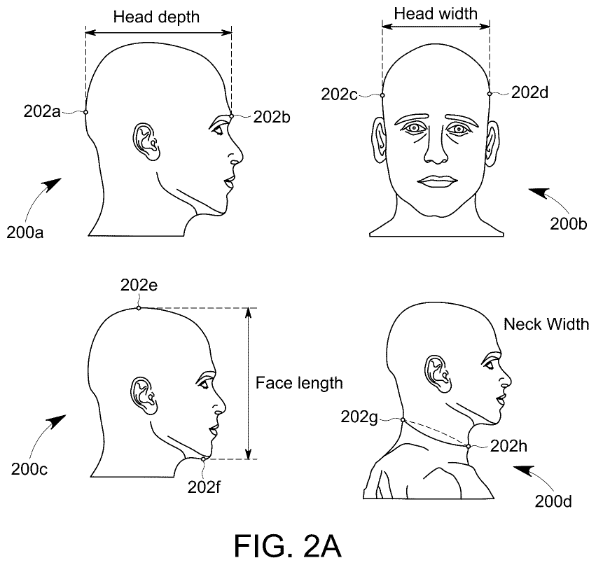

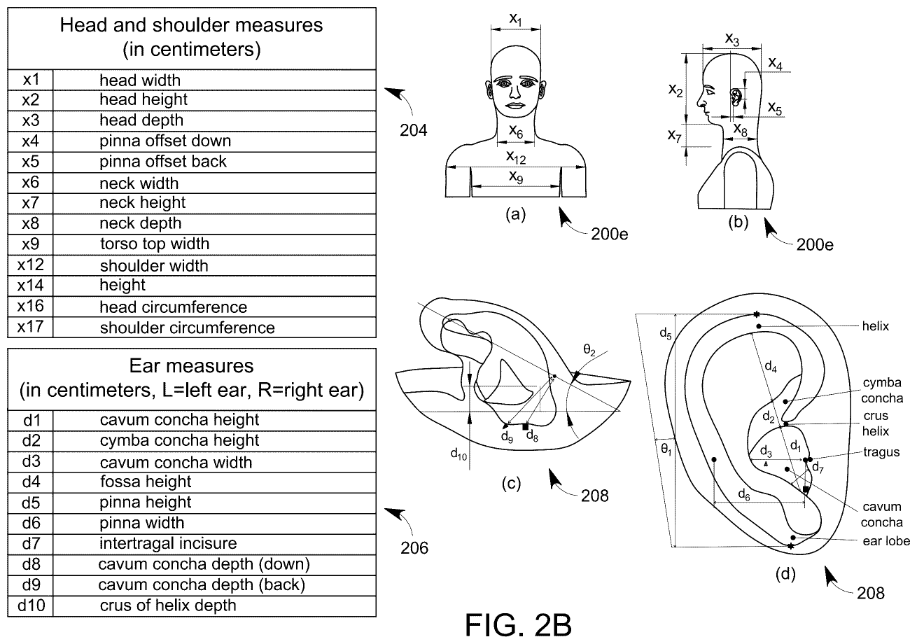

The base data set can include acoustical leakage measurements associated with each human subject of the plurality of human subjects corresponding to the base set of headphones. The base data set can also include three-dimensional (3D) scans of each human subject of the plurality of human subjects (e.g., a 3D-scanned human subject 200a-200e), as depicted in FIGS. 2A and 2B. For example, the 3D scans may be generated by any scanning mechanism and/or technique.

As is depicted in FIG. 2A, the 3D-scanned human subject 200a-200d can be utilized as a basis for a processor 104 of the system 100 to identify at least one or more anthropometric landmarks for each human subject of the plurality of human subjects. As an example, the 3D-scanned human subject 200a-200d can indicate anthropometric landmarks associated with a head depth (e.g., as illustrated by the arrow from 202a-202b), a head width (e.g., as illustrated by the arrow from 202c-202d), a face length (e.g., as illustrated by the arrow from 202e-202f), or a neck width (e.g., as illustrated by the arrow from 202g-202h) such as on a display screen (not shown) as is depicted in FIG. 2A. More specifically, the processor 104 is configured to identify an anthropometric feature associated with the scan indicating the head depth based on a first anthropometric landmark 202a and a second anthropometric landmark 202b. The processor 104 is also configured to identify an anthropometric feature associated with the scan indicating the head width based on a third anthropometric landmark 202c and a fourth anthropometric landmark 202d. The processor 104 is further configured to identify an anthropometric feature associated with the scan indicating the face length based on a fifth anthropometric landmark 202e and a sixth anthropometric landmark 202f. The processor 104 is additionally configured to identify an anthropometric feature associated with the scan indicating the neck width based on a seventh anthropometric landmark 202g and an eighth anthropometric landmark 202h.

As an additional example, other anthropometric features categorized as separate head and shoulder measurements 204 and/or ear measurements 206 can be identified by the processor 104 based on the indication of at least two anthropometric landmarks associated with the 3D-scanned human subject 200a-200d. As yet another example, and as is depicted in FIG. 2B, the head and shoulder measurements 204 can include a head width (e.g., “x1”), a head height (e.g., “x2”), a head depth (e.g., “x3”), a pinna offset down (e.g., “x4”), a pinna offset back (e.g., “x5”), a neck width (e.g., “x6”), a neck height (e.g., “x7”), a neck depth (e.g., “x8”), a torso top width (e.g., “x9”), a shoulder width (e.g., “x12”), a height (e.g., “x14”), a head circumference (e.g., “x16”), a shoulder circumference (e.g., “x17”), or a combination thereof. As a further example, any of the head and shoulder measurements 204 can be indicated upon the 3D-scanned human subject 200e, as is shown in FIG. 2B. It is understood that the listing of example measurements included as part of the head and shoulder measurements 204 depicted in FIG. 2B is non-limiting and that the head and shoulder measurements 204 can include any number of head and shoulder-related measurements not listed therein.

As a further example, the ear measurements 206 can include a cavum concha height (e.g., “d1”), a cymba concha height (e.g., “d2”), a cavum concha width (e.g., “d3”), a fossa height (e.g., “d4”), a pinna height (e.g., “d5”), a pinna width (e.g., “d6”), an intertragal incisure (e.g., “d7”), a cavum concha depth [down](e.g., “d8”), a cavum concha depth [back](e.g., “d9”), a crus of helix depth (e.g., “d10”), or a combination thereof, among others. As a further example, any of the ear measurements 206 can be indicated upon the 3D-scanned ear 208, as is shown in FIG. 2B. It is understood that the listing of example measurements included as part of the ear measurements 206 depicted in FIG. 2B is non-limiting and that the ear measurements 206 can include any number of ear measurements not listed therein.

In other words, the processor 104 is configured to determine anthropometric features based on the identified landmarks associated with each human subject of the plurality of human subjects. In one or more embodiments, the processor 104 generally has access to and uses a regression model 106 and a clustering algorithm 108. The regression model 106 is configured to determine correlations between each identified anthropometric feature and the acoustical leakage measurements associated with each human subject of the plurality of human subjects included as part of the base data set. The regression model 106 is further configured to rank the determined correlations between each identified anthropometric feature and the acoustical leakage measurements associated with each human subject of the plurality of human subjects included as part of the base data set.

Based on the ranking of the determined correlations, the processor 104 is configured to narrow (e.g., limit or reduce) the base data set to a particular number of human subjects of the plurality of human subjects (e.g., a subset of human subjects) associated with anthropometric features most correlated to the acoustical leakage measurements associated with the plurality of human subjects. For example, the processor 104 may be configured to narrow the base data set to any number of human subjects. In other words, the processor 104 is configured to select certain human subjects of the plurality of human subjects associated with anthropometric features most correlated to the acoustical leakage measurements associated with the plurality of human subjects for clustering.

The clustering algorithm 108 is configured to run a clustering program on the selected human subjects to generate clusters of varying groupings of the human subjects. In other words, the clustering algorithm 108 is configured to run a program on the anthropometric features identified to have the highest correlation to the acoustical leakage measurements. For example, the varying groupings of the human subjects can include at least one group of three human subjects (e.g., N=3), at least one group of four human subjects (e.g., N=4), and/or at least one group of five human subjects (e.g., N=5). However, different numbers of human subjects can be defined, and relative performance compared.

The processor 104 is also configured to compare clustering metrics (e.g., silhouette scores) for each of the generated clusters and select a group of the varying groupings with the best results (e.g., the highest quality clusters). For example, clusters with the highest quality are defined as the clusters that are as distinct as possible from other clusters of the varying groupings (e.g., having the least possible overlap with other clusters). While the clustering metrics may include silhouette scores, the clustering metrics can also include other scores related to the processing of a generic clustering process, for example.

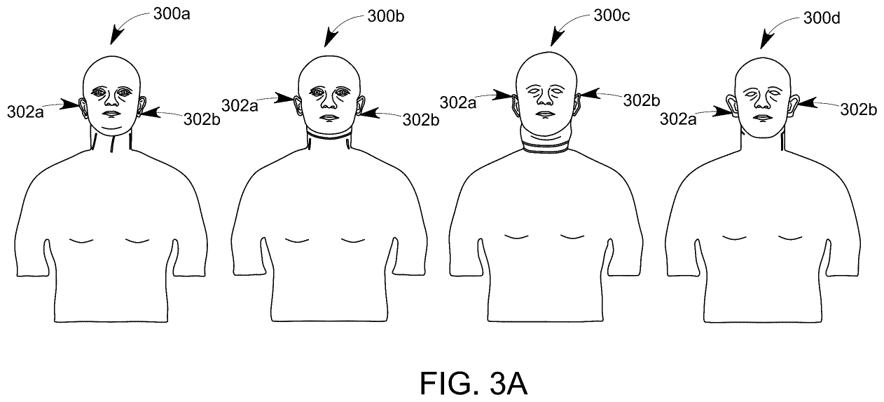

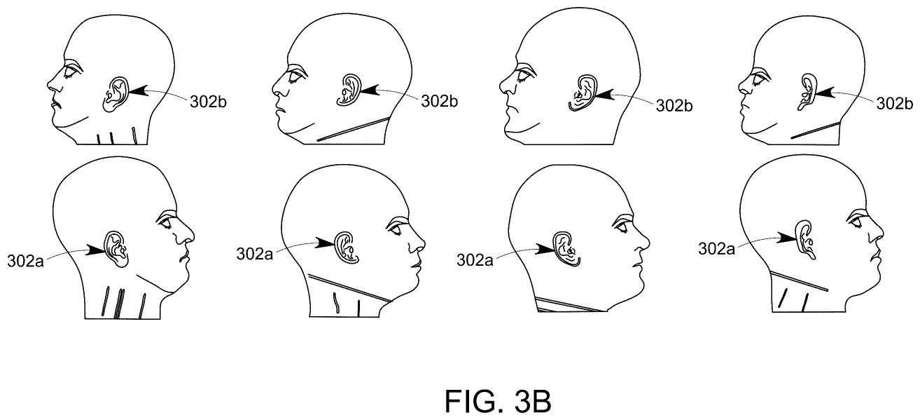

The system 100 facilitates the construction of the test object(s) 300a-300d for determining acoustical-related measurements using an output 110. For example, the output 110 can include one or more values generated from the operation of any component associated with the processor 104 such as the regression model 106 and/or the clustering algorithm 108. As an example, the test object(s) 300a-300d is constructed based on the 3D scans associated with each of the human subjects selected for clustering. While each of the test object(s) 300a-300d represent different anthropometric measurements as is inferred by the illustration of FIGS. 3A and 3B, it is understood that each of the test object(s) 300a-300d can have the same anthropometric measurements. Additionally, while FIGS. 3A and 3B depict four (e.g., “4”) test objects, it is understood that the system 100 may facilitate the construction of any number of test objects that may be used in the testing of headphones. More specifically, the test object(s) 300a-300d depicted in FIGS. 3A and 3B depict a mannequin head resembling a human head including pinnae 302a, 302b disposed upon the test object(s) 300a-300d. For example, the pinnae 302a, 302b can include at least an ear canal extension and a microphone that closely mimics the acoustic properties of the human ear. While the test object(s) 300a-300d resembles a human head, it is understood that the test object(s) 300a-300d may resemble any object. As an example, the disposition of the pinnae 302a, 302b are anatomically accurate based on a regular disposition (e.g., an expected disposition) of pinnae upon a normal human head. As another example, the pinnae 302a, 302b are formed from a malleable material such as silicone or other alternative materials that may be generally acceptable to use instead of silicone, or in combination with silicone.

As an example process, a first set of acoustical-related measurements may be obtained by testing a new set of headphones (e.g., 6-12 headphones) positioned upon (e.g., seated upon ears) a number of human subjects (e.g., at least 20 human subjects). It is understood that the acoustical-related measurements may be obtained by testing any number of headphones positioned upon any number of human subjects. It is also understood that the new set of headphones can be an initial version of a headphone model that can represent a headphone under design before any improvements are made. However, it is also understood that the new set of headphones can also be an improved headphone under design associated with the base set of headphones. For example, any of the processes described herein may be repeated to improve (e.g., optimize) the headphone under design. A second set of acoustical-related measurements may also be obtained by testing the same new set of headphones positioned upon each of the test object(s) 300a-300d. It is understood that, for the first set of acoustical-related measurements, an average acoustical leakage and an average variance associated with the acoustical leakage may be determined based on the acoustical-related measurements of each of the number of human subjects. It is also understood that for the second set of acoustical-related measurements, an average acoustical leakage and an average variance associated with the acoustical leakage may be determined based on repeated testing of the same new set of headphones seated upon multiple test objects (e.g., the test object(s) 300a-300d). It is understood that the new set of headphones may be tested on any number of test objects.

As another example process, a regression line is generated by determining a correlation between an average of the first set of acoustical-related measurements and an average of the second set of acoustical-related measurements. For example, the regression line can indicate the average acoustical leakage and the average variance associated with the acoustical leakage. As another example a first regression line can indicate the average acoustical leakage and a second regression line can indicate the average variance associated with the acoustical leakage.

As yet another example, a benchmarking process can be completed by measuring each new headphone to be benchmarked and positioned upon each of the test objects (e.g., the test object(s) 300a-300d). For example, a minimum of four headphone re-seats upon each of the test objects are used to perform the benchmarking process. However, it is understood that any number of re-seats can be used to perform the benchmarking process (e.g., to converge to a benchmark value). The benchmarking process can also include using the regression line to predict an average acoustical leakage and/or an average variance associated with the acoustical leakage for a general population of humans. For example, the prediction of the average acoustical leakage and/or the average variance associated with the acoustical leakage for the general population of humans can be based on the measurements of each of the test objects (e.g., the test object(s) 300a-300d) utilized as part of the benchmarking process.

It is understood that each of the operations described as part of the system 100, as well as operations described as part of any other example process (e.g., the benchmarking process), may be displayed on the display screen of a computing device (e.g., a user device such as a computer or a smart phone) so that any of the steps of a process associated with the system 100, and/or the operations described as part of the example process, may be monitored by a user (e.g., operator).

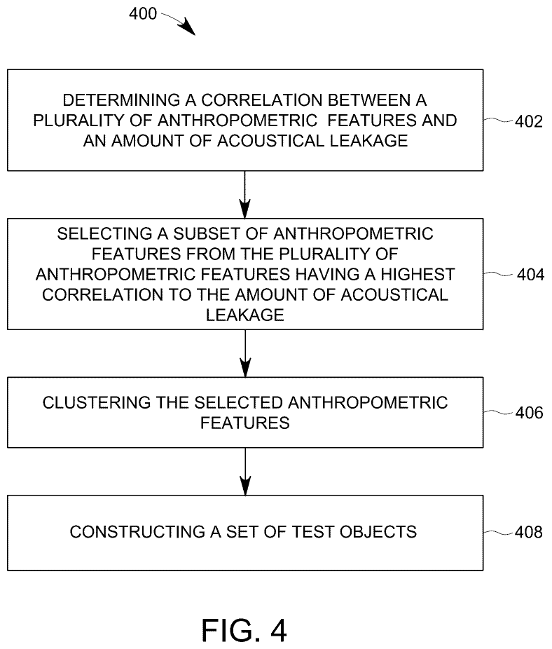

FIG. 4 is a flowchart illustrating an example method 400 for designing a test object (e.g., the test object(s) 300a-300d). For example, the test object is a mannequin head resembling a human head. At operation 402, a correlation between a plurality of anthropometric features and an amount of acoustical leakage associated with a first set of headphones is determined. As an example, the correlation between the plurality of anthropometric features and the amount of acoustical leakage associated with the first set of headphones is determined by a processor (e.g., the processor 104) using a regression model (e.g., the regression model 106).

At operation 404, a subset of anthropometric features from the plurality of anthropometric features having a highest correlation to the amount of acoustical leakage are selected for clustering. As an example, the subset can be any number of anthropometric features from the plurality of anthropometric features described herein (e.g., as is depicted in FIG. 2B). For example, the selection of the plurality of anthropometric features having the highest correlation to the amount of acoustical leakage is based on the determined correlation. At operation 406, the selected anthropometric features are clustered using a clustering algorithm (e.g., the clustering algorithm 108). As an example, the selection of the anthropometric features is clustered by the processor. At operation 408, a set of test objects are constructed. For example, the set of test objects are constructed based on one or more three-dimensional scans (e.g., the 3D-scanned human subjects 200a-200e and/or the 3D-scanned ear 208) associated with the clustered anthropometric features. For example, one or more measurements or properties of one or more three-dimensional scans having the clustered anthropometric features are used to construct the test objects.

In one or more example embodiments, a data set is obtained from each human subject of a plurality of human subjects. For example, the data set includes the amount of acoustical leakage, the one or more three-dimensional scans, or a combination thereof. In another example one or more embodiments, a plurality of anthropometric landmarks (e.g., the head and shoulder measurements 204 and/or the ear measurements 206) associated with each human subject of the plurality of human subjects is identified. For example, the identification of the plurality of anthropometric landmarks associated with each human subject of the plurality of human subjects is based on the one or more three-dimensional scans. Additionally, the plurality of anthropometric features is identified. For example, the identification of the plurality of anthropometric features is identified based on the plurality of anthropometric landmarks.

In yet another one or more example embodiments, the clustered anthropometric features are identified. For example, the identification of the clustered anthropometric features is based on one or more clustering metrics. In additional one or more example embodiments, a first set of acoustical-related measurements associated with a second set of headphones is determined. For example, the first set of acoustical-related measurements associated with the second set of headphones is determined for a plurality of human subjects. As another example, the first set of acoustical-related measurements includes an average acoustical leakage and/or an average variance associated with the average acoustical leakage. Additionally, a second set of acoustical-related measurements associated with the second set of headphones is determined. For example, the second set of acoustical-related measurements associated with the second set of headphones is determined for the set of test objects. As another example, the second set of acoustical-related measurements includes an average acoustical leakage and/or an average variance associated with the average acoustical leakage.

Furthermore, in one or more example embodiments, a regression line is generated. For example, the regression line is generated based on a correlation between the first set of acoustical-related measurements and the second set of acoustical-related measurements. Also, in another one or more example embodiments, an average acoustical leakage and/or an average variance associated with a general population of humans is predicted. For example, the prediction of the average acoustical leakage and/or the average variance is based on a slope of the regression line. As another example, the slope of the regression line may be mathematically calculated based on points on a graph, although other methods of calculating the slope of the regression line may be applied.

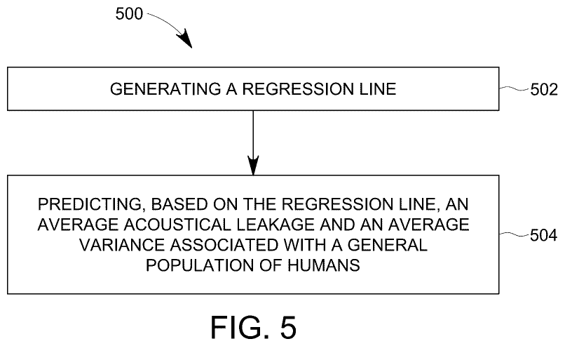

FIG. 5 is a flowchart illustrating an example method 500 for predicting acoustical-related measurements based on a test object (e.g., the test object(s) 300a-300d). For example, the test object is a mannequin head resembling a human head. At operation 502, a regression line is generated. For example, the regression line is generated based on a correlation between a first set of acoustical-related measurements and a second set of acoustical-related measurements. As another example, the first set of acoustical-related measurements is associated with a plurality of human subjects. As yet another example, the first set of acoustical-related measurements includes an average acoustical leakage and/or an average variance associated with the average acoustical leakage. As an additional example, the second set of acoustical-related measurements is associated with a set of test objects. As a further example, the second set of acoustical-related measurements includes an average acoustical leakage and/or an average variance associated with the average acoustical leakage.

At operation 504, an average acoustical leakage and/or an average variance associated with a general population of humans is predicted. For example, the prediction of the average acoustical leakage and/or the average variance is based on a slope of the regression line. As another example, each of the prediction of the average acoustical leakage and the average variance are associated with a first set of headphones. As yet another example, the slope of the regression line may be mathematically calculated based on points on a graph, although other methods of calculating the slope of the regression line may be applied.

In an example one or more embodiments, the set of test objects are constructed based on one or more three-dimensional scans (e.g., the 3D-scanned human subjects 200a-200e and/or the 3D-scanned ear 208) associated with clustered anthropometric features. For example, a subset of anthropometric features from a plurality of anthropometric features are clustered by a processor (e.g., the processor 104) using a clustering algorithm (e.g., the clustering algorithm 108). As an example, the subset can be any number of anthropometric features from the plurality of anthropometric features described herein (e.g., as is depicted in FIG. 2B). As another example, the subset of anthropometric features are selected based on a highest correlation to an amount of acoustical leakage associated with a second set of headphones. As yet another example, the highest correlation is determined by the processor using a regression model (e.g., the regression model 106). As a further example, the determination of the highest correlation is based on a determination of a correlation between the subset of anthropometric features and the amount of acoustical leakage associated with the second set of headphones.

In another example one or more embodiments, a data set is obtained from each human subject of a plurality of human subjects. For example, the data set includes the amount of acoustical leakage associated with the second set of headphones, the one or more three-dimensional scans, or a combination thereof. As yet another example one or more embodiments, a plurality of anthropometric landmarks (e.g., the head and shoulder measurements 204 and/or the ear measurements 206) associated with each human subject of the plurality of human subjects is identified. For example, the identification of the plurality of anthropometric landmarks is based on the one or more three-dimensional scans. Additionally, the plurality of anthropometric features is identified. For example, the identification of the plurality of anthropometric features is identified based on the plurality of anthropometric landmarks. In an additional example one or more embodiments, the clustered anthropometric features are identified. For example, the identification of the clustered anthropometric features is based on one or more clustering metrics.

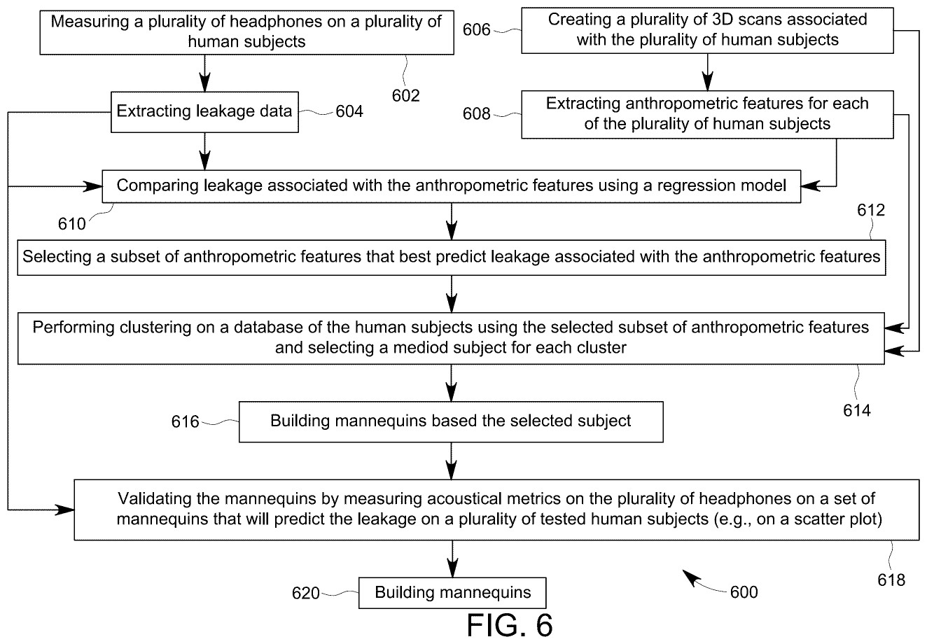

FIG. 6 depicts a process-flow illustrating an example process 600 for constructing a set of test objects (e.g., the test object 300a-300e). For example, the process-flow illustrated and referred to as FIG. 6 is similar, though not identical, to the methods explained in the description associated with FIGS. 4 and 5, respectively, and can be performed as part of or in combination with one or more embodiments described herein. At operation 602, a plurality of headphones (e.g., twelve headphones) are measured on a plurality of human subjects (e.g., twenty-five human subjects). However, it is understood that any number of headphones may be measured on any number of human subjects. At operation 604, leakage data is extracted from the measurements obtained from the plurality of headphones (e.g., in operation 602). For example, the leakage data may be associated with acoustical properties such as, but not limited to, an amount of acoustical leakage.

At operation 606, a plurality of 3D scans (e.g., the 3D-scanned human subject 200a-200e and/or the 3D-scanned ear 208) are created associated with the plurality of human subjects. It is understood that the plurality of 3D scans may be created by any scanning mechanism and/or technique. At operation 608, one or more anthropometric features (e.g., the head and shoulder measurements 204 and/or the ear measurements 206) are extracted (e.g., determined) for each of the plurality of human subjects. For example, the one or more anthropometric features may be determined based on a plurality of anthropometric landmarks (e.g., the anthropometric landmarks 202a-202h) associated with each of the plurality of human subjects.

At operation 610, leakage associated with the anthropometric features of each of the plurality of human subjects are compared. For example, the comparison can be performed using a regression model (e.g., the regression model 106). As another example, the comparison is based on the extraction of the leakage data (e.g., in operation 604) and/or the extraction of the anthropometric features for each of the plurality of human subjects (e.g., in operation 608). At operation 612, a subset of the extracted anthropometric features is selected (e.g., twelve anthropometric features). However, it is understood that any number of anthropometric features may be selected. For example, the selected subset predicts leakage associated with each of the anthropometric features of the subset. As another example, the selected subset best (e.g., most accurately) predicts the leakage associate with each of anthropometric features of the subset.

At operation 614, clustering is performed on a database of the human subjects (e.g., a large database of 340 human subjects). However, it is understood that any number of human subjects may be used in the performance of the clustering process. For example, the clustering can be performed using a clustering algorithm (e.g., the clustering algorithm 108). As another example, the clustering is performed using the selected subset of anthropometric features and or a mediod subject (e.g., four mediod subjects) for each cluster. However, it is understood that any number of mediod subjects may be used for each cluster. As an additional example, the mediod subject may be a representation of a human (e.g., or human-like) subject that reflects average anthropometric features associated with the selected subset.

At operation 616, mannequins (e.g., four mannequins) are built based on the selected mediod subject. However, it is understood that any number of mannequins may be built based on the selected mediod subject. At operation 618, the mannequins are validated by measuring acoustical metrics on the plurality of headphones (e.g., twelve headphones) on the set of mannequins (e.g., four mannequins). However, it is understood that any number of headphones may be used in the validation process associated with the mannequins. It is also understood that any number of mannequins may be used in the validation process associated with the mannequins. As an example, the validation of the mannequins will predict the leakage on a plurality of tested human subjects (e.g., twenty-five human subjects). However, it is understood that the leakage may be predicted on any number of human subjects. As another example, the prediction of the leakage on the plurality of tested human subjects can be represented on a scatter plot. However, it is understood that the prediction of the leakage on the plurality of tested human subjects can be graphically represented in any way. At operation 620, mannequins are built based on the validation of the mannequins and the prediction of the leakage on the plurality of tested human subjects (e.g., in operation 618).

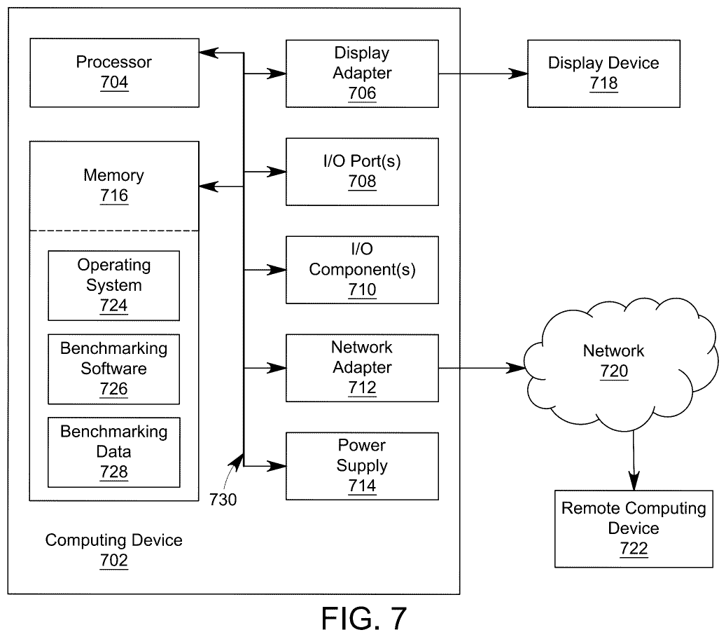

FIG. 7 illustrates an operating environment that facilitates the performance of the systems and methods described herein. More specifically, the systems and methods described herein can be implemented on a computing device 702. For example, the computing device 702 can be a personal computer, a desktop, a laptop, a tablet, a hand-held computer, a server, a workstation, a mainframe, a wearable computer, a supercomputer, or a combination thereof. However, it is understood that the aforementioned examples of what the computing device 702 may be is non-exhaustive and that the computing device 702 can be any related device. The computing device 702 generally includes a processor 704, a display adapter 706, one or more input/output port(s) 708, one or more input/output component(s) 710, a network adapter 712, a power supply 714, and a memory 716. However, it is understood that the computing device 702 can include any additional components therein and is not required to include any of the listed components (e.g., the processor 704, the display adapter 706, the one or more input/output port(s) 708, the one or more input/output component(s) 710, the network adapter 712, the power supply 714, and the memory 716).

The processor 704 is configured to provide instructions and/or processing power to the computing device 702 so that the computing device 702 can process one or more tasks including the implementation of a software program. It is also understood that the computing device 702 may include any number or processors 704 therein. The display adapter 706 can be a graphics card or a video board that provides the computing device 702 with a capability to display content on a display device 718. For example, the display device 718 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of what the display device 718 may be is non-exhaustive and that the display device 718 can be any related device.

The input/output port(s) 708 provides a number of sockets for one or more cables to connect to the computing device 702. It is understood that there may be any number of input/output port(s) 708 on the computing device 702. For example, the input/output port(s) 708 provides a means for the computing device 702 to receive signals and/or data from an external device connected to the computing device 702 via the one or more cables. As another example, the input/output port(s) 708 provides a means for the computing device 702 to send signals and/or data from an external device connected to the computing device 702 via the one or more cables. The input/output component(s) 710 can include one or more components that support the input/output port(s) 708 such as, but not limited to, a switch, a push button, a pressure mat, a float switch, a keypad, a radio receive, or a combination thereof.

A network adapter 712 can be a network interface controller that is configured to provide a means for communicating over a network 720 with another computing device, such as a remote computing device 722. For example, the remote computing device 722 can be a user device such as a cellular-phone, a smartphone, a tablet, a laptop, or a combination thereof. The power supply 714 is configured to convert alternating high voltage current (e.g., AC) into direct current (e.g., DC) to provide regulated power to the other components (e.g., the processor 704, the display adapter 706, the one or more input/output port(s) 708, the one or more input/output component(s) 710, the network adapter 712, and the memory 716) of the computing device 702.

Additionally, the memory 716 can be a mass storage device and/or a system memory such as a hard disk drive, a memory card, a solid-state drive, random access memory (RAM), or a combination thereof. The memory 716 is configured to provide a holding place for instructions and data associated with the operation of the computing device 702. The memory 716 can generally include an operating system 724, benchmarking software 726, and benchmarking data 728. For example, the operating system 724 is configured to manage and/or process any of the data and/or instructions associated with the benchmarking software 726 and/or benchmarking data 728.

Furthermore, a system bus 730 is also included within the computing device 702 that is configured to couple each of the various components (e.g., the processor 704, the display adapter 706, the one or more input/output port(s) 708, the one or more input/output component(s) 710, the network adapter 712, the power supply 714, and the memory 716) of the computing device 702. It is also understood that each of the components of the computing device 702, and the functionality associated with each of the components of the computing device 702, may be implemented within the remote computing device 722. While the operating environment illustrated within FIG. 7 depicts a particular configuration associated with at least the computing device 702, the network 720, and the remote computing device 722 it is understood that the operating environment may be configured in any way.

Thus, one or more examples of the present disclosure provides a means for predicting acoustical leakage and/or a variance associated with the acoustical leakage for a set of headphones to optimize the design process of the set of headphones before commercialization of the set of headphones. Such an optimization of the design process of the set of headphones is performed by utilizing at least one test object representative of a large sampling of demographically-diverse human subjects designed and constructed as described in more detail herein.

Based on a foregoing, the following provides a general overview of the present disclosure and is not a comprehensive summary. In a first one or more embodiments A1, a method comprising the determination, by a processor using a regression model, a correlation between a plurality of anthropometric features and an amount of acoustical leakage associated with a first set of headphones. A subset of anthropometric features from the plurality of anthropometric features having a highest correlation to the amount of acoustical leakage is selected for clustering based on the determined correlation. The selected anthropometric features are clustered, by the processor, using a clustering algorithm. A set of test objects are constructed based on one or more three-dimensional scans associated with the clustered anthropometric features.

In a second one or more embodiments A2, which may include the first one or more embodiments A1, a data set is obtained from each human subject of a plurality of human subjects, wherein the data set includes the amount of acoustical leakage, the one or more three-dimensional scans, or a combination thereof. In a third one or more embodiments A3, which may include any combination of the first through second one or more embodiments A1-A2, a plurality of anthropometric landmarks associated with each human subject of the plurality of human subjects is identified based on the one or more three-dimensional scans. The plurality of anthropometric features is identified based on the plurality of anthropometric landmarks. In a fourth one or more embodiments A4, which may include any combination of the first through third one or more embodiments A1-A3, the clustered anthropometric features are identified based on one or more clustering metrics.

In a fifth one or more embodiments A5, which may include any combination of the first through fourth one or more embodiments A1-A4, a first set of acoustical-related measurements associated with a second set of headphones is determined for a plurality of human subjects, wherein the first set of acoustical-related measurements includes an average acoustical leakage and an average variance associated with the average acoustical leakage. A second set of acoustical-related measurements associated with the second set of headphones are determined for the set of test objects, wherein the second set of acoustical-related measurements includes an average acoustical leakage and an average variance associated with the average acoustical leakage. In a sixth one or more embodiments A6, which may include any combination of the first through fifth one or more embodiments A1-A5, a regression line is generated based on a correlation between the first set of acoustical-related measurements and the second set of acoustical-related measurements. In a seventh one or more embodiments A7, which may include any combination of the first through sixth one or more embodiments A1-A6, an average acoustical leakage and an average variance associated with a general population of humans is predicted based on a slope of the regression line.

In an eight one or more embodiments A8, which may include any combination of the first through seventh one or more embodiments A1-A7, a system, comprising a processor; and a non-transitory computer-readable medium including instructions that are executable by the processor, wherein the instructions include: determining, by the processor using a regression model, a correlation between a plurality of anthropometric features and an amount of acoustical leakage associated with a first set of headphones; selecting, for clustering, based on the determined correlation, a subset of anthropometric features from the plurality of anthropometric features having a highest correlation to the amount of acoustical leakage; clustering, by the processor, the selected anthropometric features using a clustering algorithm; and constructing a set of test objects based on one or more three-dimensional scans associated with the clustered anthropometric features. In a ninth one or more embodiments A9, which may include any combination of the first through eighth one or more embodiments A1-A8, the instructions further include: obtaining, from each human subject of a plurality of human subjects, a data set, wherein the data set includes the amount of acoustical leakage, the one or more three-dimensional scans, or a combination thereof.

In a tenth one or more embodiments A10, which may include any combination of the first through ninth one or more embodiments A1-A9, the instructions further include: identifying a plurality of anthropometric landmarks associated with each human subject of the plurality of human subjects based on the one or more three-dimensional scans; and identifying the plurality of anthropometric features based on the plurality of anthropometric landmarks. In an eleventh one or more embodiments A11, which may include any combination of the first through tenth one or more embodiments A1-A10, the instructions further include: identifying the clustered anthropometric features based on one or more clustering metrics. In a twelfth one or more embodiments A12, which may include any combination of the first through eleventh one or more embodiments A1-A11, the instructions further include: determining, for a plurality of human subjects, a first set of acoustical-related measurements associated with a second set of headphones, wherein the first set of acoustical-related measurements includes an average acoustical leakage and an average variance associated with the average acoustical leakage; determining, for the set of test objects, a second set of acoustical-related measurements associated with the second set of headphones, wherein the second set of acoustical-related measurements includes an average acoustical leakage and an average variance associated with the average acoustical leakage; and generating a regression line based on a correlation between the first set of acoustical-related measurements and the second set of acoustical-related measurements. In a thirteenth one or more embodiments A13, which may include any combination of the first through twelfth one or more embodiments A1-A12, the instructions further include: predicting, based on a slope of the regression line, an average acoustical leakage and an average variance associated with a general population of humans.

In a fourteenth one or more embodiments A14, which may include any combination of the first through thirteenth one or more embodiments A1-A13, a method comprising the generation of a regression line based on a correlation between a first set of acoustical-related measurements and a second set of acoustical-related measurements, wherein the first set of acoustical-related measurements are associated with a plurality of human subjects and includes an average acoustical leakage and an average variance associated with the average acoustical leakage, and wherein the second set of acoustical-related measurements is associated with a set of test objects and includes an average acoustical leakage and an average variance associated with the average acoustical leakage. The prediction, based on a slope of the regression line, of an average acoustical leakage and an average variance associated with a general population of humans, wherein each of the prediction of the average acoustical leakage and the average variance are associated with a first set of headphones. In a fifteenth one or more embodiments A15, which may include any combination of the first through fourteenth one or more embodiments A1-A14, the set of test objects are constructed based on one or more three-dimensional scans associated with clustered anthropometric features, wherein a subset of anthropometric features from a plurality of anthropometric features are clustered by a processor using a clustering algorithm.

In a sixteenth one or more embodiments A16, which may include any combination of the first through fifteenth one or more embodiments A1-A15, the subset of anthropometric features are selected based on a highest correlation to an amount of acoustical leakage associated with a second set of headphones. In a seventeenth one or more embodiments A17, which may include any combination of the first through sixteenth one or more embodiments A1-A16, the highest correlation is determined by the processor using a regression model based on a determination of a correlation between the subset of anthropometric features and the amount of acoustical leakage associated with the second set of headphones. In an eighteenth one or more embodiments A18, which may include any combination of the first through seventeenth one or more embodiments A1-A17, a data set is obtained from each human subject of the plurality of human subjects, wherein the data set includes the amount of acoustical leakage associated with the second set of headphones, the one or more three-dimensional scans, or a combination thereof. In a nineteenth one or more embodiments A19, which may include any combination of the first through eighteenth one or more embodiments A1-A18, a plurality of anthropometric landmarks associated with each human subject of the plurality of human subjects is identified based on the one or more three-dimensional scans. The plurality of anthropometric features is identified based on the plurality of anthropometric landmarks.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
determining, by a processor using a regression model, a correlation between a plurality of anthropometric features and an amount of acoustical leakage associated with a first set of headphones;
selecting, for clustering, based on the determined correlation, a subset of anthropometric features from the plurality of anthropometric features having a highest correlation to the amount of acoustical leakage;
clustering, by the processor, the selected anthropometric features using a clustering algorithm; and
constructing a set of test objects based on one or more three-dimensional scans associated with the clustered anthropometric features.

2. The method of claim 1, further comprising:
obtaining, from each human subject of a plurality of human subjects, a data set, wherein the data set includes the amount of acoustical leakage, the one or more three-dimensional scans, or a combination thereof.

3. The method of claim 2, further comprising:
identifying a plurality of anthropometric landmarks associated with each human subject of the plurality of human subjects based on the one or more three-dimensional scans; and
identifying the plurality of anthropometric features based on the plurality of anthropometric landmarks.

4. The method of claim 1, further comprising:
identifying the clustered anthropometric features based on one or more clustering metrics.

5. The method of claim 1, further comprising:
determining, for a plurality of human subjects, a first set of acoustical-related measurements associated with a second set of headphones, wherein the first set of acoustical-related measurements includes an average acoustical leakage and an average variance associated with the average acoustical leakage; and
determining, for the set of test objects, a second set of acoustical-related measurements associated with the second set of headphones, wherein the second set of acoustical-related measurements includes an average acoustical leakage and an average variance associated with the average acoustical leakage.

6. The method of claim 5, further comprising:
generating a regression line based on a correlation between the first set of acoustical-related measurements and the second set of acoustical-related measurements.

7. The method of claim 6, further comprising:
predicting, based on a slope of the regression line, an average acoustical leakage and an average variance associated with a general population of humans.

8. A system comprising:
a processor; and
a non-transitory computer-readable medium including instructions that are executable by the processor, wherein the instructions include:
determining, by the processor using a regression model, a correlation between a plurality of anthropometric features and an amount of acoustical leakage associated with a first set of headphones;
selecting, for clustering, based on the determined correlation, a subset of anthropometric features from the plurality of anthropometric features having a highest correlation to the amount of acoustical leakage;
clustering, by the processor, the selected anthropometric features using a clustering algorithm; and
constructing a set of test objects based on one or more three-dimensional scans associated with the clustered anthropometric features.

9. The system of claim 8, wherein the instructions further include:
obtaining, from each human subject of a plurality of human subjects, a data set, wherein the data set includes the amount of acoustical leakage, the one or more three-dimensional scans, or a combination thereof.

10. The system of claim 9, wherein the instructions further include:
identifying a plurality of anthropometric landmarks associated with each human subject of the plurality of human subjects based on the one or more three-dimensional scans; and
identifying the plurality of anthropometric features based on the plurality of anthropometric landmarks.

11. The system of claim of claim 8, wherein the instructions further include:
identifying the clustered anthropometric features based on one or more clustering metrics.

12. The system of claim 8, wherein the instructions further include:
determining, for a plurality of human subjects, a first set of acoustical-related measurements associated with a second set of headphones, wherein the first set of acoustical-related measurements includes an average acoustical leakage and an average variance associated with the average acoustical leakage;
determining, for the set of test objects, a second set of acoustical-related measurements associated with the second set of headphones, wherein the second set of acoustical-related measurements includes an average acoustical leakage and an average variance associated with the average acoustical leakage; and
generating a regression line based on a correlation between the first set of acoustical-related measurements and the second set of acoustical-related measurements.

13. The system of claim 12, wherein the instructions further include:
predicting, based on a slope of the regression line, an average acoustical leakage and an average variance associated with a general population of humans.

14. A method comprising:
generating a regression line based on a correlation between a first set of acoustical-related measurements and a second set of acoustical-related measurements, wherein the first set of acoustical-related measurements are associated with a plurality of human subjects and includes an average acoustical leakage and an average variance associated with the average acoustical leakage, and wherein the second set of acoustical-related measurements is associated with a set of test objects and includes an average acoustical leakage and an average variance associated with the average acoustical leakage; and
predicting, based on a slope of the regression line, an average acoustical leakage and an average variance associated with a general population of humans, wherein each of the prediction of the average acoustical leakage and the average variance are associated with a first set of headphones.

15. The method of claim 14, further comprising:
constructing the set of test objects based on one or more three-dimensional scans associated with clustered anthropometric features, wherein a subset of anthropometric features from a plurality of anthropometric features are clustered by a processor using a clustering algorithm.

16. The method of claim 15, wherein the subset of anthropometric features are selected based on a highest correlation to an amount of acoustical leakage associated with a second set of headphones.

17. The method of claim 16, wherein the highest correlation is determined by the processor using a regression model based on a determination of a correlation between the subset of anthropometric features and the amount of acoustical leakage associated with the second set of headphones.

18. The method of claim 16, further comprising:
obtaining, from each human subject of the plurality of human subjects, a data set, wherein the data set includes the amount of acoustical leakage associated with the second set of headphones, the one or more three-dimensional scans, or a combination thereof.

19. The method of claim 16, further comprising:
identifying a plurality of anthropometric landmarks associated with each human subject of the plurality of human subjects based on the one or more three-dimensional scans; and
identifying the plurality of anthropometric features based on the plurality of anthropometric landmarks.

20. The method of claim 15, further comprising:
identifying the clustered anthropometric features based on one or more clustering metrics.
